(19) United States
(12) Patent Application Publication
(10) Pub. No.: US 2024/0236040 A9
(43) Pub. Date: Jul. 11, 2024

(54) DEVICE FOR BLOCKING HACKING AND METHOD THEREFOR

(71) Applicant: NEXTNCOM INC, Seoul (KR)

(72) Inventor: Tae Yun KWON, Seoul (KR)

(21) Appl. No.: 18/279,285

(22) PCT Filed: Jun. 17, 2022
(86) PCT No.: PCT/KR2022/008612

§ 371 Date: Aug. 29, 2023

(30) Foreign Application Priority Data
Jun. 21, 2021 (KR) 10-2021-0080245

(51) Int. Cl. H04L 9/40

(52) U.S. Cl. CPC H04L 63/0236; H04L 63/101

(57) ABSTRACT

The present invention provides a device for blocking hacking and a method therefor. That is, according to the present invention: when access is attempted by a terminal, an IP address of the terminal attempting the access is identified, and the access of the terminal is blocked if the IP address is included in a preconfigured blacklist; if the IP address is not included in the blacklist, a destination port of the terminal is identified; in response to the identified destination port of the terminal, the terminal is provided with a screen including an alert message and an input form for inputting an ID and a password, which is a dummy process; when the terminal transmits an ID and a password, it is determined, depending on the number of transmissions, that the terminal has attempted the access for hacking purposes, and the access of the terminal is thus blocked.

### TECHNICAL FIELD

The present disclosure relates to a hacking prevention device and a method thereof, and more particularly to a hacking prevention device and a method thereof using which, in the case of an access attempt of a terminal, when an IP address of a terminal attempting access is identified to be included in a preset blacklist, access of the corresponding terminal is blocked, and when the IP address of the terminal is not included in the blacklist, a destination port of the corresponding terminal is identified, an image including an input form for inputting an ID and a password and a warning message is provided to the terminal in response to the identified destination port of the terminal as a dummy process, and the corresponding terminal transmits an ID and a password, the corresponding terminal is determined to attempt access for hacking depending on the number of transmission, access of the corresponding terminal is blocked, and the IP address of the corresponding terminal is updated to the blacklist.

### BACKGROUND ART

Hacking refers to intruding into a computer of someone else through a computer communication network without permission and illegally using, changing, or destroying stored information or programs.

Such hacking is attempted on an internal network or server network from a terminal possessed by a hacker located in the outside through an external network, or attempted on the internal network or server network through the internal network from a terminal possessed by the hacker located on the internal network.

With regard to hacking by foreign or domestic external users with the development of the Internet, IP address scanning based on a network bandwidth and stealing attempts of accounts and data have frequently occurred through an ID and a password based on an executed application port.

### DISCLOSURE

### Technical Problem

One object of the present disclosure is to provide a hacking prevention device and a method thereof using which, in the case of an access attempt of a terminal, when an IP address of a terminal attempting access is identified to be included in a preset blacklist, access of the corresponding terminal is blocked, and when the IP address of the terminal is not included in the blacklist, a destination port of the corresponding terminal is identified, an image including an input form for inputting an ID and a password and a warning message is provided to the terminal in response to the identified destination port of the terminal as a dummy process, and the corresponding terminal transmits an ID and a password, the corresponding terminal is determined to attempt access for hacking depending on the number of transmission, access of the corresponding terminal is blocked, and the IP address of the corresponding terminal is updated to the blacklist

Another object of the present disclosure is to provide a hacking prevention device and a method thereof, which automatically block access of a corresponding terminal based on a start point according to transmission of an ID and a password from the corresponding terminal for a dummy process provided to a terminal attempting access and block access of the terminal attempting hacking through multiple stages of verification according to a blocking policy set in a communication network.

### Technical Solution

In accordance with one aspect of the present disclosure, provided is a hacking prevention device including a storage configured to store a blacklist, and a controller configured to, when a terminal attempts access, identify a destination port of the terminal, provide an image to the terminal according to the identified destination port, provide an input error image indicating a state in which an ID and a password are input incorrectly when the terminal transmits the ID and the password in response to the image provided to the terminal, accumulate a preset count value, map the accumulated count value to an IP address of the terminal to manage the count value, block the access of the terminal when the accumulated count value exceeds a preset reference value according to IDs and passwords that are repeatedly transmitted from the terminal, and update the IP address of the terminal to a blacklist.

As an example related to the present disclosure, the controller may identify the IP address of the terminal attempting the access, determine whether a current state is a state in which the identified IP address of the terminal attempting the access is included in the blacklist preregistered in the storage, and identify a destination port of the terminal when the current state is a state in which the identified IP address of the terminal attempting the access is not included in the blacklist preregistered in the storage, as a determination result.

As an example related to the present disclosure, as the determination result, the controller may reject the access of the terminal when the current state is the state in which the identified IP address of the terminal attempting the access is included in the blacklist preregistered in the storage.

As an example related to the present disclosure, when a current state is a state in which the terminal attempts the access through an external network, the controller may automatically register the IP address of the terminal to the blacklist and update a security policy.

As an example related to the present disclosure, when a current state is a state in which the terminal attempts the access through an internal network, the controller may be configured to automatically register the IP address of the terminal to the blacklist and block the access of the IP address of the terminal registered in the blacklist to an internal network and an external network.

In accordance with one aspect of the present disclosure, provided is a hacking prevention method including, when a terminal attempts access, identifying a destination port of the terminal by a controller, providing an image to the terminal according to the identified destination port, by the controller, providing an input error image indicating a state in which an ID and a password are input incorrectly, by the controller, when the terminal transmits the ID and the password in response to the image provided to the terminal, accumulating a preset count value, and mapping the accumulated count value to an IP address of the terminal to manage the count value, and blocking the access of the terminal when the accumulated count value exceeds a preset reference value according to IDs and passwords that are repeatedly transmitted from the terminal, and updating the IP address of the terminal to a blacklist, by the controller.

As an example related to the present disclosure, the image may include at least one of an input form for inputting an ID and a password, a transmission menu for requesting transmission of the input ID and password, and a warning message for guiding that access is blocked due to suspected hacking when an ID and a password are input to the input form.

As an example related to the present disclosure, the image may be a process in which login is not possible even if IDs and passwords are repeatedly input.

As an example related to the present disclosure, the providing of the image to the terminal according to the identified destination port may include any one of providing the image including an input form for inputting an ID and a password as a common line interface (CLI) image corresponding to the destination port of the terminal when the identified destination port is a port for a SSH protocol or a port for a telnet protocol, and a warning message for guiding that access is blocked due to suspected hacking when an ID and a password are input and transmitted to the input form, to the terminal, when the identified destination port is a port for a web browser protocol, providing the image including the input form that is a web image corresponding to the destination port of the terminal, a transmission menu for requesting transmission of the input ID and password, and the warning message, to the terminal, when the identified destination port is remote desktop connection, providing the image including the input form, the transmission menu, and the warning message, to the terminal, and when the identified destination port is DB connection, providing the image including the input form, the transmission menu, and the warning message, to the terminal.

As an example related to the present disclosure, the hacking prevention method may further include, when a hacking prevention device including the controller is operatively associated with security equipment, updating a security policy managed by the security equipment, by the controller.

### Advantageous Effects

According to the present disclosure, in the case of an access attempt of a terminal, when an IP address of a terminal attempting access is identified to be included in a preset blacklist, access of the corresponding terminal may be blocked, and when the IP address of the terminal is not included in the blacklist, a destination port of the corresponding terminal is identified, an image including an input form for inputting an ID and a password and a warning message is provided to the terminal in response to the identified destination port of the terminal as a dummy process, and the corresponding terminal transmits an ID and a password, the corresponding terminal may be determined to attempt access for hacking depending on the number of transmission, access of the corresponding terminal may be blocked, and the IP address of the corresponding terminal may be updated to the blacklist, and accordingly, since only malicious hacking attempts are blocked, a general user has no problem using the internal service network or the Internet, and more stable and faster speed may be provided.

In addition, the present disclosure may provide a service network that protects an internal/external infrastructure and is reliable by automatically blocking access of a corresponding terminal based on a start point according to transmission of an ID and a password from the corresponding terminal for a dummy process provided to a terminal attempting access, blocking access of the terminal attempting hacking through multiple stages of verification according to a blocking policy set in a communication network, and by primarily blocking the most basic IP address used in the Internet, and may reduce the number of cases of false detections.

### DESCRIPTION OF DRAWINGS

FIG. 1 is a block diagram showing components of a hacking prevention device according to an embodiment of the present disclosure.

FIG. 2 is a diagram showing an example of an entire system to which a hacking prevention device is applied for a method of processing a general hacking attempt on an external network according to an embodiment of the present disclosure.

FIG. 3 is a diagram showing an example of an entire system to which a hacking prevention device is applied for a method of processing a general hacking attempt on an internal network according to an embodiment of the present disclosure.

FIG. 4 is a flowchart showing a hacking prevention method according to an embodiment of the present disclosure.

### BEST MODE

The terminology used herein is for the purpose of describing particular embodiments only and is not intended to be limiting of the present disclosure. Unless otherwise defined, all technical terms used herein have the same meaning as commonly understood by one of ordinary skill in the art to which this present disclosure belongs and will not be interpreted in overly wide or narrow sense unless expressly so defined herein. If a term used herein is a wrong term by which one of ordinary skill in the art cannot correctly understand the present disclosure, the wrong term should be replaced by a technical term by which one of ordinary skill in the art can correctly understand the present disclosure. It will be further understood that terms, such as those defined in commonly used dictionaries, should be interpreted as having a meaning that is consistent with their meaning in the context of the relevant art and will not be interpreted in an overly narrow sense.

As used herein, the singular forms “a,” “an” and “the” are intended to include the plural forms as well, unless the context clearly indicates otherwise. It will be further understood that the terms “comprises” or “comprising” are not intended to included all elements or all steps described herein, but do not preclude exclusion of some elements or steps described herein or addition of one or more other elements or steps.

It will be understood that, although the terms first, second, third etc. may be used herein to describe various elements, these elements should not be limited by these terms. These terms are only used to distinguish one element from another element. For example, a first element may be termed a second element and a second element may be termed a first element without departing from the teachings of the present disclosure.

Hereinafter, the present disclosure will be described in detail by explaining exemplary embodiments of the present disclosure with reference to the attached drawings. The same reference numerals in the drawings denote like elements, and a repeated explanation thereof will not be given.

In the description of the present disclosure, certain detailed explanations of related art are omitted when it is deemed that they may unnecessarily obscure the essence of the present disclosure. The features of the present disclosure will be more clearly understood from the accompanying drawings and should not be limited by the accompanying drawings.

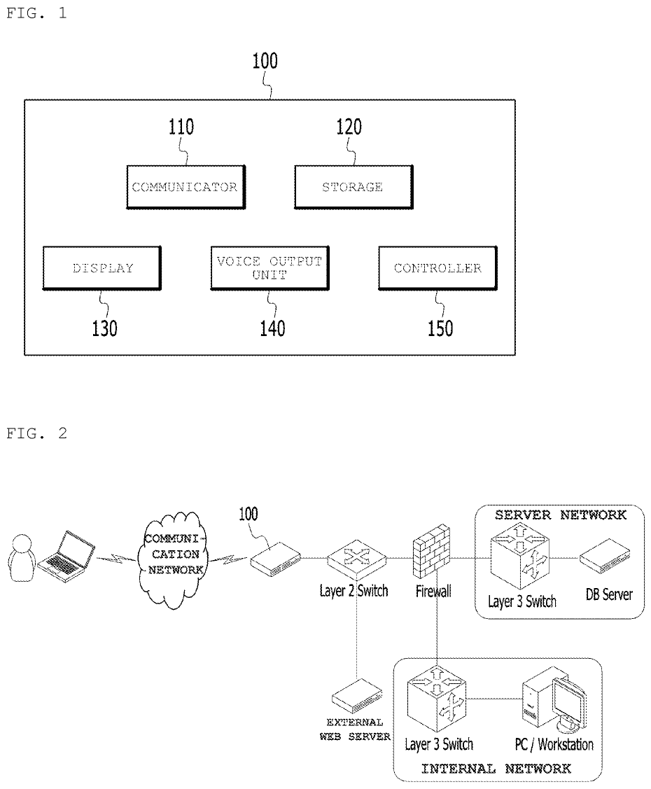

FIG. 1 is a block diagram showing components of a hacking prevention device 100 according to an embodiment of the present disclosure.

As shown in FIG. 1, the hacking prevention device 100 includes a communicator 110, a storage 120, a display 130, a voice output unit 140, and a controller 150. Not all of the components of the hacking prevention device 100 shown in FIG. 1 are necessary components, and the hacking prevention device 100 may be implemented with greater components than those shown in FIG. 1 or the hacking prevention device 100 may also be implemented with fewer components than those shown in FIG. 1.

The hacking prevention device 100 may be applied to various terminals such as a smart phone, a portable terminal, a mobile terminal, a foldable terminal, a personal digital assistant (PDA), a portable multimedia player (PMP) terminal, a telematics terminal, a navigation terminal, a personal computer, a laptop computer, a slate PC, a tablet PC, an ultrabook, a wearable device (e.g., including a smartwatch, a smart glass, and a head mounted display (HMD)), a Wibro terminal, an Internet protocol television (IPTV) terminal, a smart TV, a digital broadcast terminal, an audio video navigation (AVN) terminal, an audio/video (A/V) system, a flexible terminal, a digital signage device, and an entry gate.

The communicator 110 communicates with any internal component or at least one external terminal through a wired/wireless communication network. In this case, the external terminal may include a server (not shown), a terminal (not shown), and the like. Here, wireless internet technology includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS), and the like, and the communicator 110 may transmit and receive data according to at least one wireless Internet technology in the range including Internet technologies not listed above. In addition, a short-distance communication technology may include Bluetooth, radio frequency identification (RFID), infrared data association (IrDA), ultrawideband (UWB), ZigBee, near field communication (NFC), ultra sound communication (USC), visible light communication (VLC), Wi-Fi, Wi-Fi direct, and the like. In addition, wired communication technology may include power line communication (PLC), USB communication, Ethernet, serial communication, optical/coaxial cable, and the like.

The communicator 110 may mutually transmit information with any terminal through a universal serial bus (USB).

The communicator 110 transmits and receives a radio signal with a base station, the server, and the terminal on a mobile communication network established according to technical standards or communication methods for mobile communication (e.g., global system for mobile communication (GSM), code division multi access (CDMA), code division multi access 2000 (CDMA200), enhanced voice-data optimized or enhanced voice-data only (EV-DO), wideband CDMA (WCDMA), high speed downlink packet access (HSDPA), high speed uplink packet access (HSUPA), long term evolution (LTE), and long term evolution-advanced (LTE-A)).

The communicator 110 identifies (or detects) a terminal attempting to access an access port for a serviced server, firewall, network device, and the like under control of the controller 150.

The storage 120 may store various user interfaces (UIs), a graphic user interface (GUI), or the like.

The storage 120 stores data, a program, or the like required for an operation of the hacking prevention device 100.

That is, the storage 120 may store a plurality of application program (application program or application) driven in the hacking prevention device 100, and data and instructions for an operation of the hacking prevention device 100. At least a portion of the application program may be downloaded from an external server through wireless communication. At least a portion of the application program may be present on the hacking prevention device 100 from a time of shipment for basic functions of the hacking prevention device 100. The application program may be stored in the storage 120, installed in the hacking prevention device 100, and driven to perform an operation (or a function) of the hacking prevention device 100 by the controller 150.

The storage 120 may include at least one storage media of a flash memory type, hard disk type, multimedia card micro type, and card type memory (e.g., SD or XD memory), a magnetic memory, a magnetic disk, an optical disk, a random access memory (RAM), a static random access memory (SRAM), a read-only memory (ROM), an electrically erasable programmable read-only memory (EEPROM), and programmable read-only memory (PROM). In addition, the hacking prevention device 100 may operate a web storage that performs a storage function of the storage 120 on the Internet, or may operate in relation to the web storage.

The storage 120 stores an IP address (or IP information/start IP address/source IP address) of a terminal attempting access under control of the controller 150.

The storage 120 stores a blacklist under control of the controller 150. Here, the blacklist includes information on an IP address, a domain name, and the like that are determined or suspected to be harmful in relation to hacking and crime.

The display 130 may display various contents such as various menu images using a user interface and/or a graphic user interface stored in the storage 120 under control of the controller 150. Here, the content display on the display 130 may include a menu image including various texts or image data (including various information data) and data such as an icon, a list menu, and a combo box. The display 130 may be a touchscreen.

The display 130 may include at least one of a liquid crystal display (LCD), a thin film transistor-liquid crystal display (TFT LCD), an organic light-emitting diode (OLED), a flexible display, a 3D display, an e-ink display, and a light emitting diode (LED).

The display 130 may display an IP address or the like of a terminal attempting access under control of the controller 150.

The voice output unit 140 outputs voice information included in a predetermined signal-processed signal by the controller 150. Here, the voice output unit 140 may include a receiver, a speaker, a buzzer, and the like.

The voice output unit 140 outputs guide voice generated by the controller 150.

The voice output unit 140 outputs voice information (or sound effect) corresponding to the IP address of the terminal attempting to access under control of the controller 150.

The controller (or a microcontroller unit (MCU) 150 may perform an overall control function of the hacking prevention device 100.

The controller 150 performs the overall control function of the hacking prevention device 100 using a program or data stored in the storage 120. The controller 150 may include RAM, ROM, CPU, GPU, and a bus, and the RAM, the ROM, the CPU, the GPU, and the like may be connected to each other through a bus. The CPU may access the storage 120, perform booting using an O/S stored in the storage 120, and perform various operations using various programs, contents, data, and the like stored in the storage 120.

When access is attempted from a terminal (not shown) to an access port for a serviced server, firewall, network device, and the like, the controller 150 identifies an IP address (or IP information/start IP address/source IP address) of the terminal attempting access. Here, the terminal attempts access to the access port using information (e.g., including a well-known port, a registered port, and a dynamic port) identified according to IP address scanning, an executed application port, and the like based on a network bandwidth. In this case, the well-known port is reserved to be used by a certain privileged service in a preset port range (e.g., 1 to 1023) in the Internet assigned numbers authority (IANA). The registered port is a region used as a server socket in another preset port range (e.g., 1024 to 49151) in the IANA. In addition, the dynamic port is dynamically assigned with a port number for every access in another preset port range (e.g., 49152 to 65535) in the IANA.

The controller 150 determines (or checks) whether the current state is a state in which the identified IP address of the terminal attempting access is included in a blacklist pre-registered in the storage 120. Here, the blacklist includes information on an IP address, a domain name, and the like that are determined or suspected to be harmful in relation to hacking and crime.

As a result of the determination (or as a result of the checking), when the current state is a state in which the IP address of the terminal attempting access is included in the blacklist, the controller 150 rejects (or blocks/terminates) access of the corresponding terminal 100.

As a result of the determination (or as a result of the checking), when the current state is a state in which the IP address of the terminal attempting access is not included in the blacklist, the controller 150 identifies a destination port of the corresponding terminal. Here, the destination port may be in a state of being set to 7 for ECHO, 9 for DISCARD, 13 for DAYTIME, 20 for FTP DATA, 21 for FTP, 22 for SSH, 23 for TELNET, 25 for SMTP, 37 for TIME, 43 for WHOIS, 53 for DNS, 79 for FINGER, 80 for HTTP, 110 for POP3, 119 for NNTP, 143 for IMAP, and 443 for HTTPS according to a protocol such as ECHO, DISCARD, DAYTIME, FTP DATA, FTP, SSH, TELNET, SMTP, TIME, WHOIS, DNS, FINGER, HTTP, POP3, NNTP, IMAP, or HTTPS. The destination port may be a port corresponding to a computer such as a remote desktop, ms-sql, or oracle, a server, a security device (not shown), a network device, or the like.

The controller 150 provides (or transmits) an image (or window) to the terminal according to the identified destination port (or protocol corresponding to the identified destination port). Here, the image may correspond to a dummy process and include an input form for inputting an ID and a password, a transmission menu (or transmission item/button) for requesting transmission of the input ID and password, and a warning message for guiding that access is blocked due to suspected hacking when an ID and/or a password are input and transmitted to the input form. At this time, the dummy process is a process that does not require (or does not provide) an ID (or account information) and a password and in which login is not possible even if the ID and password are repeatedly input. In addition, the image may be composed of various types of user interfaces (UI), graphic user interfaces (GUI), and the like.

That is, when the identified destination port is a port for an SSH protocol (e.g., 22) or a port for a telnet protocol (e.g., 23), the controller 150 provides the image including the input form, the warning message, and the like as a common line interface (CLI) image corresponding to a destination port of the corresponding terminal to the terminal through the communicator 110.

As such, the controller 150 provides the same image for SSH, telnet, and the like for controlling a Linux server and a network device, and thus determines that a hacker is a network device and induces an access attempt accordingly.

When the identified destination port is a port (e.g., 80 and 443) for a web browser (e.g., http and https) protocol, the controller 150 provides an image including the input form, the transmission menu, the warning message, and the like as a web image corresponding to the destination port of the corresponding terminal to the terminal through the communicator 110.

When the identified destination port is the remaining ports (or other ports) other than the ports 22, 23, 80, and 443 among well-known ports, the controller 150 provides the image including the input form, the transmission menu, the warning message, and the like to the terminal through the communicator 110 according to a protocol corresponding to the other port.

That is, when the identified destination port is remote desktop connection, the controller 150 provides the terminal with the same image of the remote desktop for controlling a windows computer and a server, and thus may determine that a hacker is the windows computer and the server and induce an access attempt accordingly.

When the identified destination port is DB connection, the controller 150 may provide the same image of a DB program to the terminal, and thus may determine that the hacker is a DB server and induce an access attempt accordingly.

The terminal receives and displays the image provided from the controller 150.

Accordingly, in the case of a general user possessing the terminal, access is terminated through checking the warning message provided to the terminal.

When the terminal transmits the ID and password received through the input form included in the image, through the image provided to the terminal, the controller 150 receives the ID and password transmitted from the terminal through the communicator 110.

The controller 150 provides (or transmits) an input error image indicating a state in which the ID and/or password are input incorrectly to the terminal through the communicator 110. At this time, according to an input method, the controller 150 may also provide the input error image to the terminal through the communicator 110 when receiving information corresponding to an enter key instead of receiving information such as an ID and a password transmitted from the terminal. Here, the input error image (or input error image of the ID and/or password) corresponds to a dummy process and includes information indicating a state in which the ID and/or the password are input incorrectly, an input form for inputting the ID and the password, a transmission menu for requesting transmission of the input ID and password, a warning message including information for guiding that access is blocked due to suspected hacking when the ID and/or the password are input and transmitted to the input form, and the like.

The controller 150 accumulates a preset count value. At this time, the controller 150 associates (or maps/matches) identification information of the terminal (or an IP address of the terminal) and the count value and manages the associated information. Here, the identification information of the terminal includes a mobile directory number (MDN), a mobile IP, a mobile MAC, subscriber identity module (Sim) card-specific information, a serial number, and the like.

The controller 150 may repeatedly perform a process of receiving an ID, a password, and the like retransmitted from the terminal in response to the input error image provided to the terminal, in response thereto, providing the input error image to the terminal again, and accumulating the count value related to the corresponding terminal (or the count value related to the IP address of the corresponding terminal). At this time, the controller 150 may also provide the input error image to the terminal through the communicator 110 again when receiving information corresponding to an enter key instead of receiving information such as the ID and the password retransmitted from the terminal.

When the accumulated count value (or the accumulated count value in relation to the IP address of the corresponding terminal) in relation to the terminal exceeds a preset reference value (including, for example, 3 times or 5 times), the controller 150 determines that the corresponding terminal attempts to access for hacking, blocks the access of the corresponding terminal, and updates the IP address of the corresponding terminal to the blacklist. Here, when the corresponding hacking prevention device 100 is operatively associated with security equipment (not shown) such as a firewall and an intrusion prevention system (IPS), the controller 150 may also update a security policy (or firewall policy) managed by the security equipment. At this time, the firewall (or the security equipment) is a network security system that monitors and controls incoming and outgoing network traffic based on a predefined security rule, is a policy-based firewall in most cases, and is configured to control traffic between networks with various levels of policy.

At this time, when the corresponding terminal attempts access through an external network, the controller 150 automatically registers the IP address of the corresponding terminal in the blacklist and updates a security policy (or rejection policy).

As such, the controller 150 may protect an internal server, a security device, a network device, and the like safely by primarily blocking access of the blocked source IP address to the internal server, and the like from the outside. At this time, the controller 150 may provide a stable service by applying secondary security in a security device that is operatively associated with the controller 150.

The controller 150 is provided with an application programming interface (API) for adding the blacklist for operative association with the security device and is operatively associated with the corresponding security device.

When there is no API, the controller 150 may add and provide a command to be added to the blacklist through CLI to CLI DB of each manufacturer.

The controller 150 may operatively associate the blocked source IP address with a security device such as a firewall, apply the blocked source IP address to a security policy of the security device, and apply a primary security policy and a secondary security policy to safely protect an infrastructure. Here, the security device may have false detection when the security policy is executed by an operator or the security device is blocked through an automatic security policy, the security device is not widely used, but only the source IP address for malicious hacking attempts may be blocked by applying the technology of the present disclosure, thereby reducing the number of false detections.

When the corresponding terminal attempts to access through an internal network, the controller 150 automatically registers the IP address of the corresponding terminal in the blacklist, and configures (or control/manage) the IP address of the corresponding terminal registered in the blacklist to block network access. Here, when virus scan and malicious code removal are completed in the terminal corresponding to the IP address of the terminal using the internal network registered in the blacklist, the controller 150 may release the blocking of access to the IP address of the corresponding terminal (or delete and process the IP address of the corresponding terminal from the corresponding blacklist).

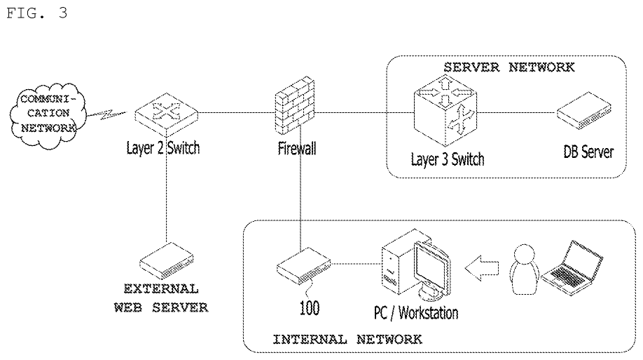

FIG. 2 is a diagram showing an example of an entire system to which the hacking prevention device 100 is applied for a method of processing a general hacking attempt on an external network according to an embodiment of the present disclosure.

In the case of the external service, hacking occurs through an attempt to access an access port for the serviced server, firewall, network device, and the like, and the hacking prevention device 100 may install a trap as shown in the above image, and seek stability for the external service by blocking an access attempt for the service and automatically registering a blacklist.

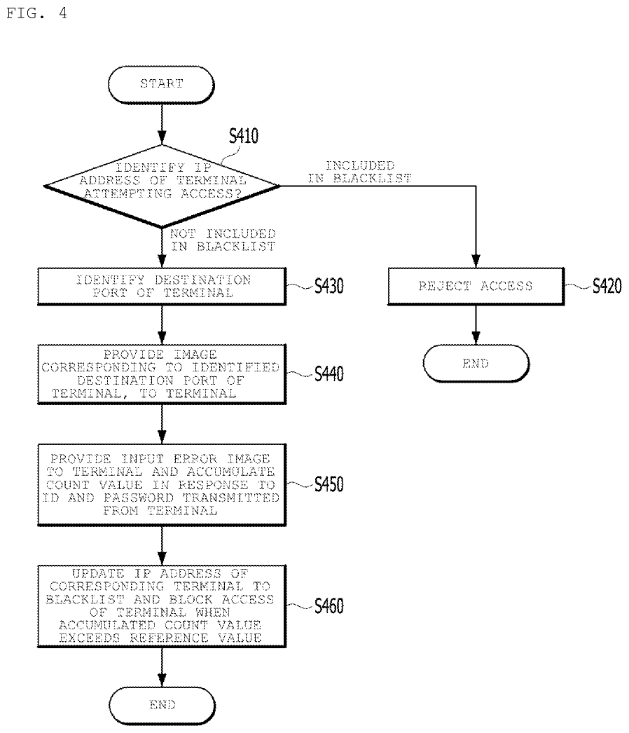

FIG. 3 is a diagram showing an example of an entire system to which the hacking prevention device 100 is applied for a method of processing a general hacking attempt on an internal network according to an embodiment of the present disclosure.

As a defense against internal hacking by infecting an internal user with malicious codes, or the like, the internal user is generally unable to access a server, or the like, but when there is an access attempt, the hacking prevention device 100 may achieve the stabilization of an internal infrastructure service by releasing a blocking policy after blocking and taking action on an online work.

Although the embodiment of the present disclosure describes that the hacking prevention device 100 is configured in a standalone form, it is not limited thereto, and various functions provided by the hacking prevention device 100 may also be configured in an application type switch (which includes, for example, a product installed on a server, a PC, or the like, access port change defined during installation, installation possibility only with an administrator account, a license issuance type, or the like) or a sensor type (which includes, for example, a component configured to set a management IP but not to perform access as a product in the form of an aggregation tap, a bridge, or a switch).

The hacking prevention device 100 may provide various functions provided by the hacking prevention device 100 in the form of a USB installation file or online download.

As such, in the case of an access attempt of a terminal, when an IP address of a terminal attempting access is identified to be included in a preset blacklist, access of the corresponding terminal may be blocked, and when the IP address of the terminal is not included in the blacklist, a destination port of the corresponding terminal is identified, an image including an input form for inputting an ID and a password and a warning message is provided to the terminal in response to the identified destination port of the terminal as a dummy process, and the corresponding terminal transmits an ID and a password, the corresponding terminal may be determined to attempt access for hacking depending on the number of transmission, access of the corresponding terminal may be blocked, and the IP address of the corresponding terminal may be updated to the blacklist.

As such, in relation to the dummy process provided to the terminal attempting access, access of the corresponding terminal may be automatically blocked based on a start point as the corresponding terminal transmits an ID and a password, and access of the terminal attempting hacking may be blocked through multiple stages of verification according to a blocking policy set in a communication network.

Hereinafter, a hacking prevention method according to the present disclosure will be described in detail with reference to FIGS. 1 to 4.

FIG. 4 is a flowchart showing a hacking prevention method according to an embodiment of the present disclosure.

First, when access is attempted from a terminal (not shown) to an access port for a serviced server, firewall, network device, and the like, the controller 150 identifies an IP address (or IP information/start IP address/source IP address) of the terminal attempting access. Here, the terminal attempts access to the access port using information (e.g., including a well-known port, a registered port, and a dynamic port) identified according to IP address scanning, an executed application port, and the like based on a network bandwidth. In this case, the well-known port is reserved to be used by a certain privileged service in a preset port range (e.g., 1 to 1023) in the IANA. The registered port is a region used as a server socket in another preset port range (e.g., 1024 to 49151) in the IANA. In addition, the dynamic port is dynamically assigned with a port number for every access in another preset port range (e.g., 49152 to 65535) in the IANA.

The controller 150 determines (or checks) whether the identified IP address of the terminal attempting access is included in a blacklist pre-registered in the storage 120. Here, the blacklist includes information on an IP address, a domain name, and the like that are determined or suspected to be harmful in relation to hacking and crime.

For example, when a first terminal (not shown) attempts access in relation to a service provided by a first server (not shown), the first controller 150 identifies an IP address of the first terminal (e.g., 100.200.100.200).

The first controller determines whether the current state is a state in which the identified IP address of the first terminal is included in a blacklist managed by the first storage 120 (S410).

As a result of the determination (or as a result of the checking), when the current state is a state in which the IP address of the terminal attempting access is included in the blacklist, the controller 150 rejects (or blocks/terminates) access of the corresponding terminal 100.

For example, when the current state is a state in which the identified IP address of the first terminal is included in the blacklist managed by the first storage, the first controller determines the corresponding first terminal to be a terminal having a hacking purpose, rejects access of the first terminal, and terminates connection with the corresponding first terminal (S420).

As a result of the determination (or as a result of the checking), when the current state is a state in which the IP address of the terminal attempting access is not included in the blacklist, the controller 150 identifies a destination port of the corresponding terminal. Here, the destination port may be in a state of being set to 7 for ECHO, 9 for DISCARD, 13 for DAYTIME, 20 for FTP DATA, 21 for FTP, 22 for SSH, 23 for TELNET, 25 for SMTP, 37 for TIME, 43 for WHOIS, 53 for DNS, 79 for FINGER, 80 for HTTP, 110 for POP3, 119 for NNTP, 143 for IMAP, and 443 for HTTPS according to a protocol such as ECHO, DISCARD, DAYTIME, FTP DATA, FTP, SSH, TELNET, SMTP, TIME, WHOIS, DNS, FINGER, HTTP, POP3, NNTP, IMAP, or HTTPS. The destination port may be a port corresponding to a computer such as a remote desktop, ms-sql, or oracle, a server, a security device, a network device, or the like.

For example, when the current state is a state in which the identified IP address of the first terminal is not included in the blacklist managed by the first storage, the first controller identifies a destination port of the first terminal (S430).

Then, the controller 150 provides (or transmits) an image (or window) to the terminal according to the identified destination port (or protocol corresponding to the identified destination port). Here, the image may correspond to a dummy process and include an input form for inputting an ID and a password, a transmission menu (or transmission item/button) for requesting transmission of the input ID and password, and a warning message for guiding that access is blocked due to suspected hacking when an ID and/or a password are input and transmitted to the input form. At this time, the dummy process is a process that does not require (or does not provide) an ID (or account information) and a password and in which login is not possible even if the ID and password are repeatedly input.

That is, when the identified destination port is a port for an SSH protocol (e.g., 22) or a port for a telnet protocol (e.g., 23), the controller 150 provides the image including the input form, the warning message, and the like as a common line interface (CLI) image corresponding to a destination port of the corresponding terminal to the terminal through the communicator 110.

When the identified destination port is a port (e.g., 80 and 443) for a web browser (e.g., http and https) protocol, the controller 150 provides an image including the input form, the transmission menu, the warning message, and the like as a web image corresponding to the destination port of the corresponding terminal to the terminal through the communicator 110.

When the identified destination port is the remaining ports (or other ports) other than the ports 22, 23, 80, and 443 among well-known ports, the controller 150 provides the image including the input form, the transmission menu, the warning message, and the like to the terminal through the communicator 110 according to a protocol corresponding to the other port.

The terminal receives and displays the image provided by the controller 150.

Accordingly, in the case of a general user possessing the terminal, access is terminated through checking the warning message provided to the terminal.

For example, when the identified destination port of the first terminal is a port 22, the first controller transmits a first image including a first input form for inputting an ID and password corresponding to 22 that is the destination port of the first terminal, a first warning message including information for guiding that access is blocked due to suspected hacking when an ID and/or a password are input and transmitted to the first input form, and the like to the first terminal through the first communicator 110.

The first terminal receives the first image transmitted through the first communicator and displays the received first image.

For another example, when the identified destination port of the first terminal is a port 80, the first controller transmits a second web page image including a second input form for inputting an ID and password corresponding to 80 that is the destination port of the first terminal, a second transmission menu for requesting transmission of the input ID and password input to the second input form, a second web page image including information for guiding that access is blocked due to suspected hacking when an ID and/or a password are input and transmitted to the second input form, and the like to the first terminal through the first communicator.

The first terminal receives the second web page image transmitted through the first communicator and displays the received second web page image (S440).

Then, when the terminal transmits the ID and password received through the input form included in the corresponding image through an image provided to the terminal, the controller 150 receives the ID and password transmitted from the terminal, through the communicator 110.

The controller 150 provides (or transmits) an input error image indicating a state in which the ID and/or password are input incorrectly to the terminal through the communicator 110. At this time, according to an input method, the controller 150 may also provide the input error image to the terminal through the communicator 110 when receiving information corresponding to an enter key instead of receiving information such as an ID and a password transmitted from the terminal. Here, the input error image (or input error image of the ID and/or password) corresponds to a dummy process and includes information indicating a state in which the ID and/or the password are input incorrectly, an input form for inputting the ID and the password, a transmission menu for requesting transmission of the input ID and password, and a warning message including information for guiding that access is blocked due to suspected hacking when the ID and/or the password are input and transmitted to the input form.

The controller 150 accumulates a preset count value. At this time, the controller 150 associates (or maps/matches) identification information of the terminal (or an IP address of the terminal) and the count value and manages the associated information. Here, the identification information of the terminal includes a MDN, a mobile IP, a mobile MAC, subscriber identity module (Sim) card-specific information, a serial number, and the like.

The controller 150 may repeatedly perform a process of receiving an ID, a password, and the like retransmitted from the terminal in response to the input error image provided to the terminal, in response thereto, providing the input error image to the terminal again, and accumulating the count value related to the corresponding terminal (or the count value related to the IP address of the corresponding terminal). At this time, the controller 150 may also provide the input error image to the terminal through the communicator 110 again when receiving information corresponding to an enter key instead of receiving information such as the ID and the password retransmitted from the terminal.

For example, the first controller receives a first ID and first password retransmitted from the first terminal through the first communicator in response to the first image pre-transmitted to the first terminal.

The first controller transmits a first input error image including information indicating a state in which an ID and/or a password are input incorrectly, a first input form for inputting an ID and a password, a first warning message including information for guiding that access is blocked due to suspected hacking when the ID and/or the password are input and transmitted to the first input form, and the like to the first terminal through the first communicator.

The first terminal receives the first input error image transmitted through the first communicator and displays the received first input error image (S450).

Then, when the accumulated count value (or the accumulated count value in relation to the IP address of the corresponding terminal) in relation to the terminal exceeds a preset reference value (including, for example, 3 times or 5 times), the controller 150 determines that the corresponding terminal attempts to access for hacking, blocks the access of the corresponding terminal, and updates the IP address of the corresponding terminal to the blacklist. Here, when the corresponding hacking prevention device 100 is operatively associated with security equipment (not shown) such as a firewall and an intrusion prevention system (IPS), the controller 150 may also update a security policy managed by the security equipment.

At this time, when the corresponding terminal attempts access through an external network, the controller 150 automatically registers the IP address of the corresponding terminal in the blacklist and updates a security policy (or rejection policy).

When the corresponding terminal attempts to access through an internal network, the controller 150 automatically registers the IP address of the corresponding terminal in the blacklist, and configures (or control/manage) the IP address of the corresponding terminal registered in the blacklist to block network access. Here, when virus scan and malicious code removal are completed in the terminal corresponding to the IP address of the terminal using the internal network registered in the blacklist, the controller 150 may release the blocking of access to the IP address of the corresponding terminal (or delete and process the IP address of the corresponding terminal from the corresponding blacklist).

For example, when an accumulated count value (e.g., 6) achieved by repeatedly performing a process of transmitting the ID and the password by the first terminal exceeds a preset reference value (e.g., 5) in relation to the IP address of the corresponding first terminal, the first controller determines the corresponding first terminal to be a terminal hacking purpose, rejects access to the first terminal, and terminates access to the corresponding first terminal.

The first controller updates the IP address of the first terminal to the blacklist (S460).

As described above, according to an embodiment of the present disclosure, in the case of an access attempt of a terminal, when an IP address of a terminal attempting access is identified to be included in a preset blacklist, access of the corresponding terminal may be blocked, and when the IP address of the terminal is not included in the blacklist, a destination port of the corresponding terminal is identified, an image including an input form for inputting an ID and a password and a warning message is provided to the terminal in response to the identified destination port of the terminal as a dummy process, and the corresponding terminal transmits an ID and a password, the corresponding terminal may be determined to attempt access for hacking depending on the number of transmission, access of the corresponding terminal may be blocked, and the IP address of the corresponding terminal may be updated to the blacklist, and accordingly, since only malicious hacking attempts are blocked, a general user has no problem using the internal service network or the Internet, and more stable and faster speed may be provided.

In addition, as described above, the embodiment of the present disclosure may provide a service network that protects an internal/external infrastructure and is reliable by automatically blocking access of a corresponding terminal based on a start point according to transmission of an ID and a password from the corresponding terminal for a dummy process provided to a terminal attempting access, blocking access of the terminal attempting hacking through multiple stages of verification according to a blocking policy set in a communication network, and primarily blocking the most basic IP address used in the Internet, and may reduce the number of cases of false detections.

The above description is merely illustrative of the technical idea of the present disclosure. Those of ordinary skill in the art to which the present disclosure pertains will be able to make various modifications and variations without departing from the essential characteristics of the present disclosure. Therefore, embodiments disclosed in the present disclosure are not intended to limit the technical idea of the present disclosure, but to describe, and the scope of the technical idea of the present disclosure is not limited by such embodiments. The scope of protection of the present disclosure should be interpreted by the claims below, and all technical ideas within the scope equivalent thereto should be construed as being included in the scope of the present disclosure.

### Mode

Modes for carrying out the disclosure have been described together in the best mode for carrying out the disclosure above.

### INDUSTRIAL AVAILABILITY

According to the present disclosure, in the case of an access attempt of a terminal, when an IP address of a terminal attempting access is identified to be included in a preset blacklist, access of the corresponding terminal may be blocked, and when the IP address of the terminal is not included in the blacklist, a destination port of the corresponding terminal is identified, an image including an input form for inputting an ID and a password and a warning message is provided to the terminal in response to the identified destination port of the terminal as a dummy process, and the corresponding terminal transmits an ID and a password, the corresponding terminal may be determined to attempt access for hacking depending on the number of transmission, access of the corresponding terminal may be blocked, and the IP address of the corresponding terminal may be updated to the blacklist, and accordingly, since only malicious hacking attempts are blocked, a general user has no problem using the internal service network or the Internet, and more stable and faster speed may be provided, thereby achieving industrial availability.

1. A hacking prevention device, comprising:
a storage configured to store a blacklist; and
a controller configured to, when a terminal attempts access, identify a destination port of the terminal, provide an image to the terminal depending upon the identified destination port, provide an input error image indicating a state in which an ID and a password are input incorrectly when the terminal transmits the ID and the password in response to the image provided to the terminal, accumulate a preset count value, map the accumulated count value to an IP address of the terminal to manage the count value, block the access of the terminal when the accumulated count value exceeds a preset reference value depending upon IDs and passwords that are repeatedly transmitted from the terminal, and update the IP address of the terminal to a blacklist.

2. The hacking prevention device according to claim 1, wherein the controller identifies the IP address of the terminal attempting the access, determines whether a current state is a state in which the identified IP address of the terminal attempting the access is included in the blacklist preregistered in the storage, and identifies a destination port of the terminal when the current state is a state in which the identified IP address of the terminal attempting the access is not included in the blacklist preregistered in the storage, as a determination result.

3. The hacking prevention device according to claim 2, wherein, as the determination result, the controller rejects the access of the terminal when the current state is the state in which the identified IP address of the terminal attempting the access is included in the blacklist preregistered in the storage.

4. The hacking prevention device according to claim 1, wherein, when a current state is a state in which the terminal attempts the access through an external network, the controller automatically registers the IP address of the terminal to the blacklist and updates a security policy.

5. The hacking prevention device according to claim 1, wherein, when a current state is a state in which the terminal attempts the access through an internal network, the controller is configured to automatically register the IP address of the terminal to the blacklist and block the access of the IP address of the terminal registered in the blacklist to an internal network and an external network.

6. A hacking prevention method, comprising:
when a terminal attempts access, identifying a destination port of the terminal by a controller;
providing an image to the terminal according to the identified destination port, by the controller;
providing an input error image indicating a state in which an ID and a password are input incorrectly, by the controller, when the terminal transmits the ID and the password in response to the image provided to the terminal;
accumulating a preset count value, and mapping the accumulated count value to an IP address of the terminal to manage the count value; and
blocking the access of the terminal when the accumulated count value exceeds a preset reference value according to IDs and passwords that are repeatedly transmitted from the terminal, and updating the IP address of the terminal to a blacklist, by the controller.

7. The hacking prevention method according to claim 6, wherein the image comprises at least one of an input form for inputting an ID and a password, a transmission menu for requesting transmission of the input ID and password, and a warning message for guiding that access is blocked due to suspected hacking when an ID and a password are input to the input form.

8. The hacking prevention method according to claim 6, wherein the image is a process in which login is not possible when IDs and passwords are repeatedly input.

9. The hacking prevention method according to claim 6, wherein the providing of the image to the terminal depending upon the identified destination port comprises any one of:
providing the image comprising an input form for inputting an ID and a password as a common line interface (CLI) image corresponding to the destination port of the terminal when the identified destination port is a port for a SSH protocol or a port for a telnet protocol, and a warning message for guiding that access is blocked due to suspected hacking when an ID and a password are input and transmitted to the input form, to the terminal;
when the identified destination port is a port for a web browser protocol, providing the image comprising the input form that is a web image corresponding to the destination port of the terminal, a transmission menu for requesting transmission of the input ID and password, and the warning message, to the terminal;
when the identified destination port is remote desktop connection, providing the image comprising the input form, the transmission menu, and the warning message, to the terminal; and
when the identified destination port is DB connection, providing the image comprising the input form, the transmission menu, and the warning message, to the terminal.

10. The hacking prevention method according to claim 6, further comprising:
when a hacking prevention device comprising the controller is operatively associated with security equipment, updating a security policy managed by the security equipment, by the controller.
